(19) United States
(12) Patent Application Publication
(10) Pub. No.: US 2025/0039336 A1
(43) Pub. Date: Jan. 30, 2025

(54) VIDEO SUMMARY GENERATION FOR VIRTUAL CONFERENCES

(71) Applicant: Zoom Video Communications, Inc., San Jose, CA (US)

(72) Inventors: Bilung Lee, San Jose, CA (US); Vijay Venkataswamy Parthasarathy, San Jose, CA (US); Yun Zhang, Pittsburgh, PA (US); Bing Zhao, San Jose, CA (US)

(21) Appl. No.: 18/359,158

(22) Filed: Jul. 26, 2023

(51) Int. Cl. H04N 7/15

(52) U.S. Cl. CPC H04N 7/155

(57) ABSTRACT

Systems and methods for video summary generation are disclosed. A chat and video conference provider generates a text summary for a meeting video and an audio summary based on the text summary. The chat and video conference provider determines a first set of correspondences between a first set of video portions from the meeting video and portions of the text summary based on a transcript of the meeting video. The chat and video conference provider determines a second set of correspondences between a second set of video portions from the meeting video and the portions of the text summary based on image data of the meeting video. The chat and video conference provider selects a plurality of video frames from the first set of the correspondences and the second set of correspondences to generate a video summary of the meeting video based on the audio summary.

### FIELD

The present application generally relates to virtual conferencing and more specifically relates to video summary generation for virtual conferences.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices;

FIG. 2 shows an example system in which a chat and video conference provider provides videoconferencing functionality to various client devices;

FIG. 3 shows an example system 300 that facilitates a virtual conference;

FIG. 4 shows an example system 400 that is configured to generate a video summary for a video recording of a virtual conference;

FIG. 5 shows an example diagram 500 that illustrates the different types of data processed or extracted during video summary generation;

FIG. 6 is an example GUI 600 enabling generation of a video summary for a video recording on demand by a host client device;

FIG. 7 is an example GUI 700 displaying a video recording and a video summary for a virtual conference on a host client device;

FIG. 8 is an example GUI 800 displaying a video recording on non-host participant client device;

FIG. 9 is an example GUI 900 enabling generation of a video summary for a video recording on demand by a non-host client device;

FIG. 10 shows an example method 1000 for generating a video summary for a meeting video;

FIG. 11 shows an example computing device suitable for use with example systems and methods for generating a video summary of a meeting video.

### DETAILED DESCRIPTION

Examples are described herein in the context of video summary generation for virtual conferences. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Virtual conferences are often recorded. If a participant cannot attend a virtual conference at the prescheduled time, the absent participant can obtain a recording of the virtual conference and review at their convenience. Participants who attended the virtual conference may also want to review the recording at later time. However, the virtual conference can be 30 minutes, an hour, or even longer than one hour. People may not have that much time or want to spend that much time reviewing the whole length of the recording. Oftentimes, they just want to have a condensed version of the recording including a summary of the virtual conference and highlights from the virtual conference.

To facilitate a participant to review a recording of a virtual conference, it is desirable for a communication platform to generate a video summary including narrated highlights from the virtual conference. For example, the communication platform provides a video summary generator for generating video summaries for video recordings.

In an example, a communication platform establishes a virtual conference among participants and records the virtual conference as it goes on. At the end of the virtual conference, the communication platform generates a video recording of the virtual conference. Meanwhile or shortly later, a transcript for the video recording is also generated.

The communication platform includes a summarization model for generating a text summary for the video recording. The textual summary can be converted to an audio summary using text-to-speech (TTS) techniques. The audio summary can be 30 seconds to 1 minute long, in this example. The textual summary can include multiple sentences. Each sentence corresponds to a portion of the audio summary. Accordingly, the audio summary includes multiple portions.

The communication platform determines portions in the transcript that match or are most relevant to the text or audio summary. Since the transcript includes time stamps, time ranges for the transcript portions can be identified. A first set of video portions corresponding to the identified time ranges are also identified. The first set of video portions identified via transcript can be mapped to the multiple portions of the audio summary. The communication platform thus identifies a first set of correspondences between the first set of video portions from the video recording and the text or audio summary.

In parallel or in series, the communication platform also identifies a second set of correspondences between a second set of video portions of the video recording and the text or audio summary. The communication platform analyzes the image data in the video recording and identifies the video images that match or are most relevant to the text or audio summary. Video portions that include these images are the second set of video portions mapped to the text or audio summary to form the second set of correspondences.

The communication platform identifies key moments or highlights from the first set of correspondences and the second set of correspondences. Examples of visual key moments are presentation graphs, group photos, emojis. Examples of audio key moments are positive (or negative) sentiments, high (or low) engagement, heated discussion (or lack of discussion), etc. Examples of textual key moments include special terminologies and named entities in the transcript. The communication platform then selects video frames including some or all of the identified key moments and align the selected video frames to the audio summary to generate a video clip. The video clip is a video summary of the video recording, with key moments or highlights along with the audio summary as the narration.

Thus, this example provides a video summary of a video recording. The video summary includes an audio narrating the summary of the meeting along with key moments or highlights displaying in video. A user can get the essence of the meeting without having to review the entirety of the video recording. It does not only save the user's time, but also identifies important information for the user's attention.

This illustrative example is given to introduce the reader to the general subject matter discussed herein and the disclosure is not limited to this example. The following sections describe various additional non-limiting examples and examples of video summary generation for virtual conferences.

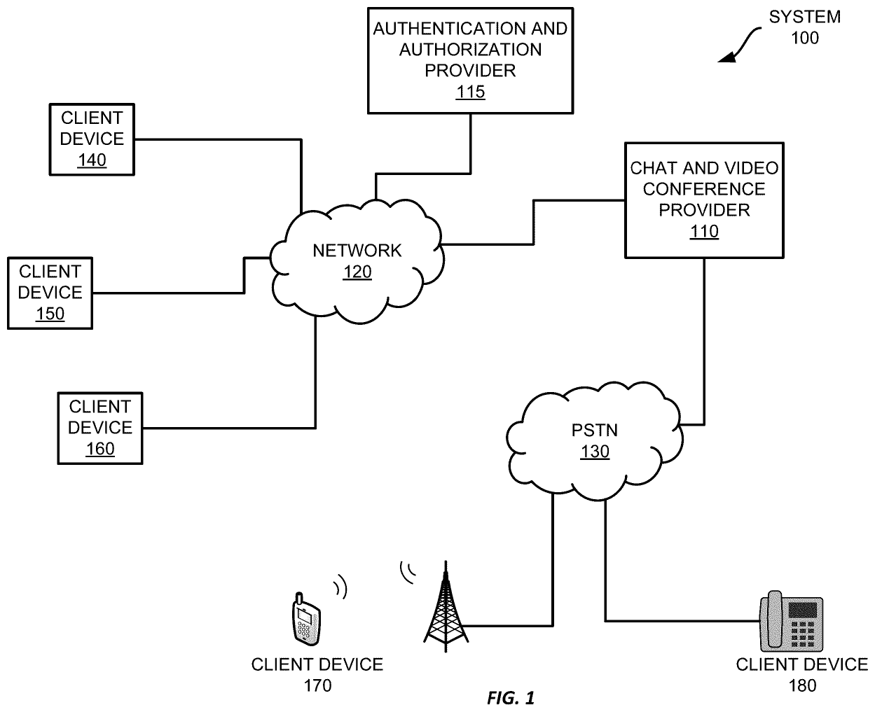

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

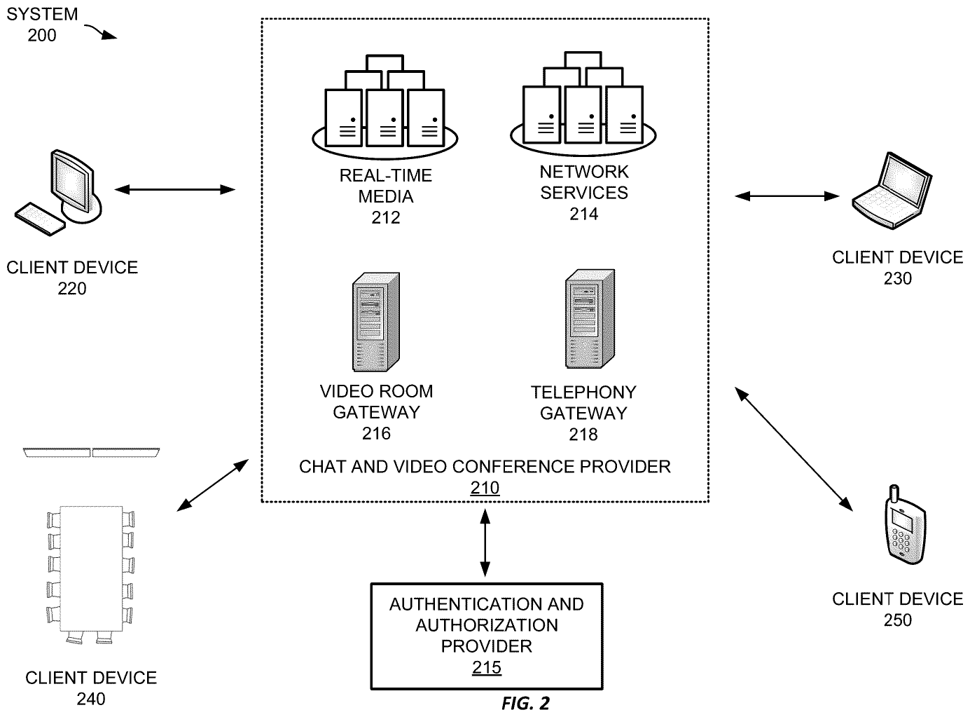

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220′s own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real- time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real- time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

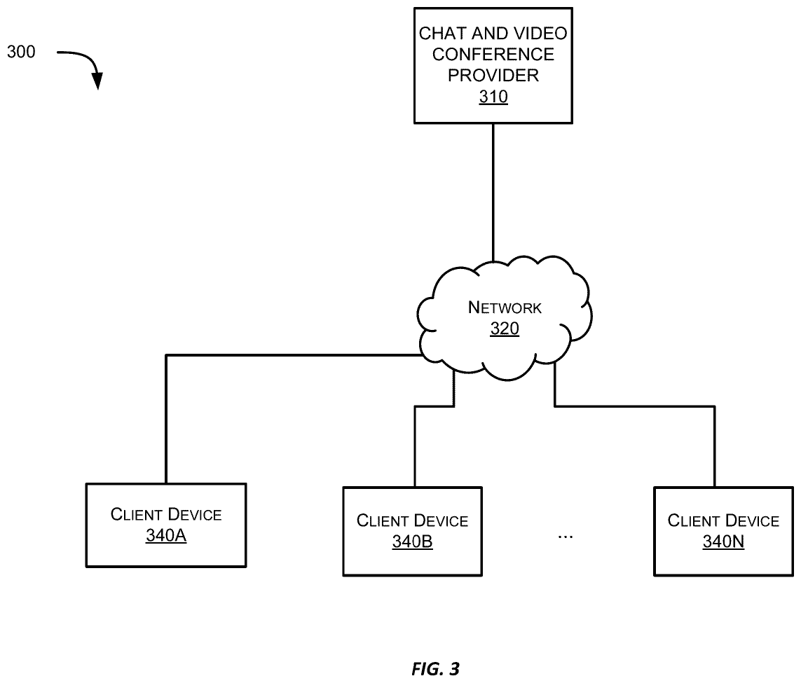

Referring now to FIG. 3, FIG. 3 shows an example system 300 that facilitates a virtual conference. In this example system 300, a chat and video conference provider 310 and a number of client device 340A-340N (which may be referred to herein individually as a client device 340 or collectively as the client devices 340) are connected via a network 320. The chat and video conference provider 310 can be the chat and video conference provider 110 in FIG. 1 or the chat and video conference provider 210 in FIG. 2. The network 320 can be the internet or any suitable communications network or combination of communications network may be employed, including LANs (e.g., within a corporate private LAN), WANs, MANs, cellular network (e.g., 3G, 4G, 4G LTE, 5G, etc.), or any combination of these.

The client devices 340 can be any suitable computing or communications device. The client device 340 can be a client device (e.g., 140, 150, 160, or 170) in FIG. 1 or a client device (e.g., 220, 230, or 250) in FIG. 2. For example, client devices 340 may be desktop computers, laptop computers, tablets, smart phones having processors and computer-readable media, connected to the chat and video conference provider 310 using the internet or other suitable computer network. The client devices 340 have chat and video conference software installed to enable them to connect to the chat and video conference provider 310. A user associated a client device (e.g., client device 340A) joins a virtual conference established among client devices associated with different users via the chat and video conference provider 310. Some users may speak, present, interact, or react during the virtual conference.

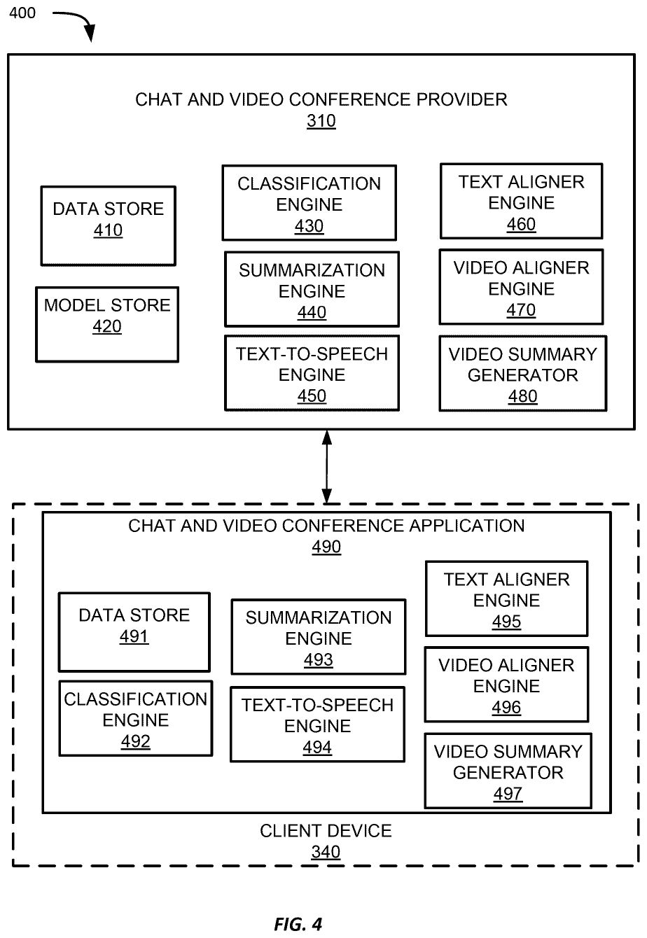

Now referring to FIG. 4, FIG. 4 shows an example system 400 that is configured to generate a video summary for a video recording of a virtual conference. The chat and video conference provider 310 is in network communication with a client device 340. The client device 340 is installed with a chat and video conference application 490 provided by the chat and video conference provider 310.

The chat and video conference provider 310 includes a model store 420. The model store 420 stores different artificial intelligence or machine learning (AI/ML) models that can be used during the process of generating a video summary for a video recording of a virtual conference. Various types of models or artificial intelligence algorithms may be used in example systems. For example, simple ML models, such as Linear Regression and Gradient Boosting may be used. In other examples, more sophisticated models, such as Factorization Machines (“FM”). As more data is available in a system according to these examples, deep learning models may be utilized, such as DeepFM and Wide&Deep or other similar models. Other alternative ML models that might be used include a deep convolutional neural network (“CNN”), a residual neural network (“Resnet”), or a recurrent neural network, e.g., long short-term memory (“LSTM”) models or gated recurrent units (“GRUs”) models. The ML model can also be any other suitable ML model, such as a three-dimensional CNN (“3DCNN”), a dynamic time warping (“DTW”) technique, a hidden Markov model (“HMM”), etc., or combinations of one or more of such techniques-e.g., CNN-HMM or MCNN (Multi-Scale Convolutional Neural Network). Further, some examples may employ adversarial networks, such as generative adversarial networks (“GANs”), or may employ autoencoders (“AEs”) in conjunction with ML models, such as AEGANs or variational AEGANs (“VAEGANs”). Some ML models may use transformer networks or self-attention based neural networks. Some Some AI/ML models are generative AI models, such as generative pre-trained transformer (GPT), Text-to-Text Transfer Transformer (T5), Bidirectional and Auto-Regressive Transformer (BART), Bidirectional Encoder Representations from Transformer (BERT), their variations, or other large language models (LLMs) or foundation models (FM). The AI/ML models in the model store 420 can be supervised or unsupervised learning models.

The chat and video conference provider 310 can include a classification engine 430 configured for classifying a virtual conference or its corresponding video recording. In some examples, the chat and video conference provider 310 selects an ML model from the model store 420 and train the ML model for classification. Classification involves matching an item with a class or group. The classification model can be based on logistic regression, decision tree, random forest, support vector machine, K-nearest neighbor, naive Bayes, stochastic gradient descent, or any suitable ML algorithms for classification.

The chat and video conference provider 310 can train a classification model using a training dataset to classify a virtual conference or its video recording. In some examples, the training dataset includes a set of video recordings for different types of virtual conferences. Certain features can be derived from the set of video recordings for classifying the corresponding video recordings into certain categories. Some of the example features may include how many speakers were in the virtual conference, how long each speaker spoke, if different participants can interact with each other. The training dataset can also include metadata of the virtual conference. For example, the title of the virtual conference, description of the virtual conference from the host, etc. The virtual conferences or corresponding video recordings can be classified into different categories, for example webinars, webcasts, product demos, group discussions etc.

Even though an ML model can be used for classifying a virtual conference or corresponding video recording, the classification engine 430 is not limited to using an ML model for classification. The classification engine 430 can implement any suitable models or algorithms for classification. Alternatively, the classification engine 430 can be optional. The chat and video conference provider 310 can classify a virtual conference or corresponding video recording solely based on description of the virtual conference provided by the host of the virtual conference without implementing a classification engine 430. The chat and video conference provider 310 then provides a classification identifier or meeting classifier to the video recording of the virtual conference.

The chat and video conference provider 310 can include a summarization engine 440 configured to generate a text summary for the video recording. In some examples, the chat and video conference provider 310 selects an ML model from the model store 420 and training the ML model for summarizing a video recording based on its transcript. When training the ML model for summarization, the chat and video conference provider 310 can identify key phrases from the transcript for summarization based on the classification of the video recording. In some examples, the chat and video conference provider 310 selects and trains an ML model for summarization to extract transcript sentences including the extracted key phrases to generate a text summary. Examples of extractive summarization models include TextRank, LexRank, and Luhn. In some examples, the chat and video conference provider 310 extracts and trains an ML model for summarization to abstract and synthesize the transcript based on the classification of the video recording to generate new sentences. Examples of abstractive summarization models include BART, T5, GPT, or their variations. The chat and video conference provider 310 can train multiple ML models for summarization for multiple types of video recordings. The model store 420 can also store the multiple trained ML models for summarization.

The summarization engine 440 can include the multiple trained ML models for summarization from the model store 420 and select one trained model based on the type of a video recording. Even though in this example an ML model is used in for generating a text summary of a video recording, the summarization engine 440 is not limited to using an ML model for summary generation. The summarization engine 440 can implement any suitable models or algorithms for summarization.

The chat and video conference provider 310 can include a TTS engine 450 configured to convert the text summary generated by the summarization engine 440 to an audio summary. The text-to-speech (TTS) engine 450 can implement a deep-learning-based TTS model trained to convert written text to spoken words. The TTS engine 450 can provide different types of voices (e.g., men's voice, women's voice, accents, etc.) and different uttering speeds (e.g., word counts/min) for selection.

The chat and video conference provider 310 can include a text aligner engine 460 configured to identify video portions from the video recording corresponding to portions of the text or audio summary based on the transcript of the video recording. The text aligner engine 460 can implement a similarity learning model to identify portions in the transcript of a video recording that semantically matches portions of the text or audio summary. The similarity model can be an unsupervised similarity matching model. In some examples, the similarity model obtains embedding vectors for different portions of a text summary. One sentence can be a portion and has a corresponding embedding vector. The transcript of a video recording can also be divided into different portions, by sentences, by speakers, by time, or by any other suitable metrics. Each portion of the transcript for the video recording also has an embedding vector. A similarity score can be calculated to measure a semantic similarity between an embedding vector for a portion of the transcript and an embedding vector for a portion of the text summary. The portions of the transcript can be ranked based on corresponding similarity scores with respect to a portion of the text summary. The transcript portions with similarity scores greater than a threshold value can be identified as more similar to the portion of the text summary than other transcript portions.

The text aligner engine 460 can also implement a relevance ranking model to rank the text portions identified as similar to a portion of the text summary and select the most relevant transcript portion. The relevance ranking model can be a supervised model. The relevance ranking model can be optional. Without the relevance ranking model, the similarity matching model can select the transcript portion with the highest similarity score for each portion of the text summary.

The transcript can include time stamps for different portions of the transcript. A video portion corresponding to the most relevant transcript portion (or the transcript portion with the highest similarity score) can be identified and extracted using these time stamps to be mapped with a portion of the text summary. Thus, a set of correspondences can be determined between video portions from the video recording and portions of the text summary.

The chat and video conference provider 310 can include a video aligner engine 470 configured to identify video portions from the video recording corresponding to portions of the text or audio summary based on video images in the video recording. The video aligner engine 470 can implement Optical Character Recognition (OCR) or other suitable image-to-text techniques to recognize text in the video images. The video aligner engine 470 can implement ML models to detect and identify objects in the video images. The video aligner engine 470 may implement a supervised classification model to classify thumbnail images in the video recording to exclude back images. The text data and object data can be considered as image data. The video aligner engine 470 can implement a similarity learning model to identify the video images in a video recording that include image data matching portions of the text or audio summary of the video recording. The similarity model can be the same type of model used in the text aligner engine 460. For example, the similarity model can obtain embedding vectors for different portions of a text summary. The video frames of a video recording can also be divided into different portions, by frames, by speakers, by time, by any other suitable metrics.

The similarity model can obtain an embedding vector for the image data extracted from one or more video frames in each portion of the video recording. The similarity model measures a semantic similarity between an embedding vector for the one or more video frames in each portion of the video recording and an embedding vector for a portion of the text summary by calculating a similarity score. The video portions of the video recording can be ranked based on their similarity scores with respect to a portion of the text summary. The video portions with similarity scores greater than a threshold value can be identified as more similar to the portion of the text summary than other video portions of the video recording.

The video aligner engine 470 can also implement a relevance ranking model to rank the video portions from the video recording identified as similar to a portion of the text summary and select the most relevant video portion. The relevance ranking model can be a supervised model. The relevance ranking model can be optional. Without the relevance ranking model, the similarity learning model can select and extract the video portion with the highest similarity score to be mapped with each portion of the text summary. The video aligner engine 470 thus determines a set of correspondences between video portions from the video recording and portions of the text summary.

The chat and video conference provider 310 can also a video summary generator 480 configured to generate a video summary based on the video portions identified by the text aligner engine 460 from the video recording, the video portions identified by the video aligner engine 470 from the video recording, and the audio summary. The video summary generator 480 can determine multiple types of key moments (e.g., noteworthy moments, or highlights) to identify from the video portions identified by the text aligner engine 460 from the video recording and the video portions identified by the video aligner engine 470 from the video recording. In some examples, the video summary generator 480 determines the multiple types of key moments to identify based on a classification identifier of the video recording or corresponding virtual conference. Key moments from the video images of the video portions can include presentation graphs, group photos, emojis, speaker photos, object photos (e.g., especially when the virtual conference is or includes a demonstration). Key moments from the audio of the video portion can include different sentiments (positive or negative), unusual discussions, high (or low) engagement, etc. The video summary generator can also identify special terminologies or named entities from the transcript as key moments to be included in the video summary.

The video summary generator 480 can implement a classification model to identify key moments in the video portions identified by the text aligner engine 460, the video portions identified by the video aligner engine 470, or the transcript, corresponding to different key moment types. For example, if a video recording is for a product demonstration, the product pictures and audience engagement (e.g., questions or emojis) can be identified as key moments.

The video summary generator 480 can select a subset of key moments from all the key moments identified from the video portions determined by the text aligner engine 460 and the video portions determined by the video aligner engine 470. In some examples, the video summary generator 480 implements a supervised relevance ranking model to rank the key moments based on user preferences or the relationship to the text summary. The user preferences refer to what types of information a user (e.g., host of the virtual conference) prefers to include in the video summary. The relationship can be how similar or relevant that key moment is to the text summary compared to other key moments.

The subset of key moments can be used to generate a video summary. In some examples, the video summary generator 480 implements an entailment model to determine if a key moment from the subset of key moments (hypothesis) can be derived from a portion of the text or audio summary (premise) by calculating an entailment score. The key moments are ranked based on corresponding entailment scores with respect to a portion of the text summary. Key moments with entailment scores greater than a threshold value can be selected to be merged into a video clip for that portion of the text or audio summary. The video clip is also aligned to the narration in corresponding portion of the audio summary. Video clips for different portions of the audio summary are then merged to be a whole video clip aligned with the narration of the whole audio summary. Thus, a video summary for the video recording is generated.

The chat and video conference provider can also include a data store 410. The data store 410 can store the video recording, transcript of the video recording, classification identifier, text summary, audio summary, a first set of correspondence (or mapping) between a first set of video portions from the video recording and portions of the text or audio summary determined by the text aligner engine 460, a second set of correspondences (or mapping) between a second set of video portions from the video recording and portions of the text or audio summary determined by the video aligner engine 470, key moments, video summary. In addition, the data store can also store some other data generated during the process of video summary generation, for example, similarity scores, rankings, entailment scores, etc.

The chat and video conference application 490 installed on the client device 340 can also include a classification engine 492, a summarization engine 493, a TTS engine 494, a text aligner engine 495, a video aligner engine 496, and a video summary generator 497, similar to the corresponding engines on the chat and video conference provider 310, for generating a video summary locally at the client device 340. When the chat and video conference application 490 is just installed on the client device 340, the classification engine 492, summarization engine 493, TTS engine 494, text aligner engine 495, video aligner engine 496, and video summary generator 497 are pre-configured by the chat and video conference provider 310 with appropriate models or algorithms to perform corresponding functions. In addition, the chat and video conference application 490 can also include a local data store 491 to store a video recording, its transcription, classification identifier, text summary, audio summary, a set of correspondence (or mapping) between video portions from the video recording and portions of the text or audio summary determined by the text aligner engine 495, a set of correspondences (or mapping) between video portions from the video recording and portions of the text or audio summary determined by the video aligner engine 496, key moments, video summary, and other data generated by one or more of the engines during the process of video summary generation.

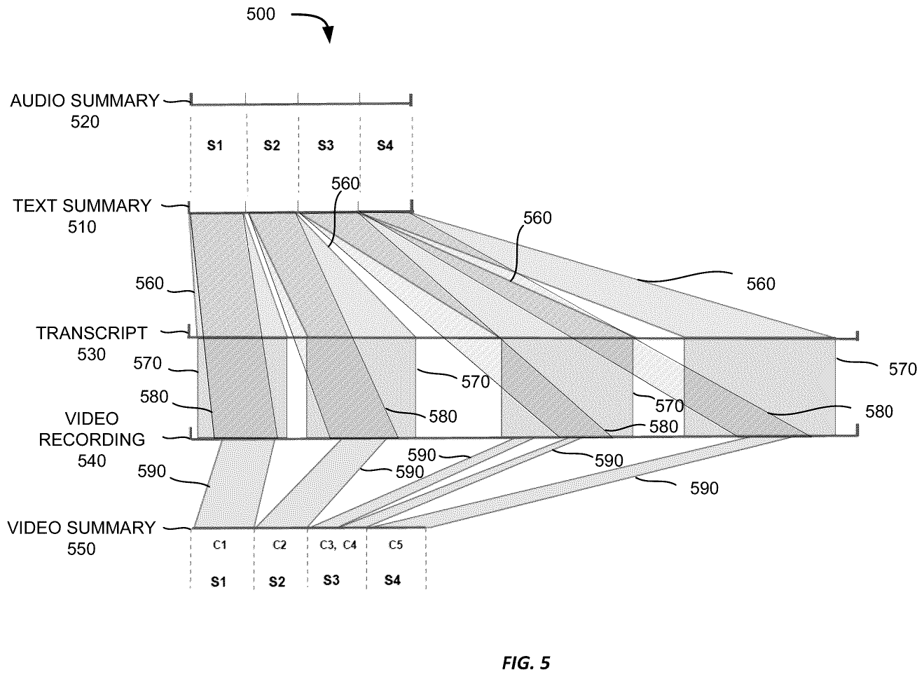

Referring now to FIG. 5, FIG. 5 shows an example diagram 500 that illustrates the different types of data processed or extracted during video summary generation. The text summary 510 is generated by a summarization engine 440 for a video recording 540. In this example, the text summary 510 includes four sentences, S1, S2, S3, and S4. An audio summary 520 is generated by a TTS engine 450 using the text summary 510. The audio summary 520 includes four sections corresponding to the four sentences in the text summary 510. A set of transcription portions 560 corresponding to the four sentences in the text summary 510 can be identified by the text aligner engine 460. Accordingly, a first set of video portions 570 in the video recording 540 can be identified corresponding to the transcript portions 560 based on respective time stamps. A second set of video portions 580 in the video recording 540 can be identified corresponding to the four sentences in the text summary 510 by the video aligner engine 470. The first set of video portions 570 and the second set of video portions 580 can be processed by the video summary generator 480 to select a set of video frames 590 representing some key moments relevant to the text summary 510. The set of video frames 590 and the audio summary 520 are then aligned and merged into a video summary 550.

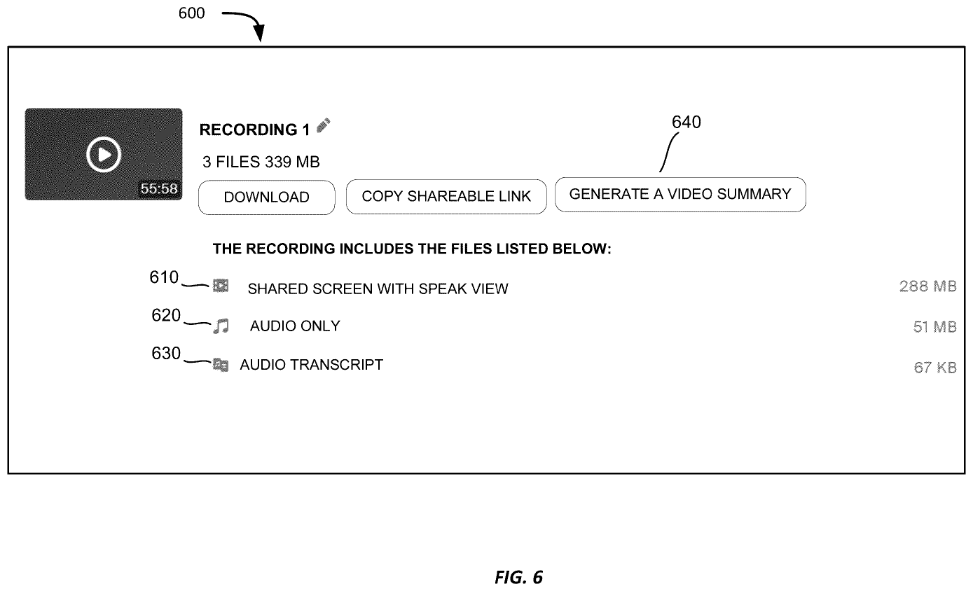

Referring now to FIG. 6, FIG. 6 is an example GUI 600 enabling generation of a video summary for a video recording on demand by a host client device. A host of a virtual conference can record the virtual conference. When the recording is available to the host after the virtual conference is concluded, example GUI 600 can be displayed if the host clicks a link to “recording 1” received from the chat and video conference provider 310. Example GUI 600 includes a video version 610 of “recording 1,” an audio version 620 of “recording 1,” and the transcript 630 of “recording 1.” In addition, example GUI 600 also includes a “generate a video summary” button 640. If the host of the concluded virtual conference clicks or press the button 640, the chat and video conference provider 310 can generate a video summary for “recording 1.”

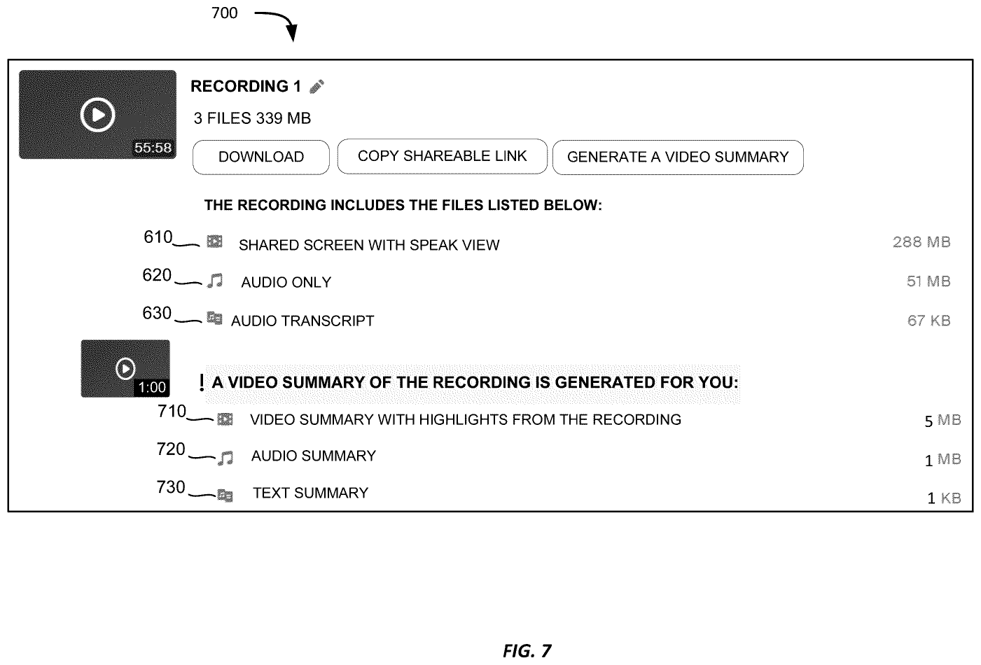

Referring now to FIG. 7, FIG. 7 is an example GUI 700 displaying a video recording and a video summary for a virtual conference on a host client device. Example GUI 700 displays the video version 610 of “recording 1,” the audio version 620 of “recording 1,” and the transcript 630 of “recording 1,” similar to those in example GUI 600 in FIG. 6. In addition, example GUI 700 also provides a condensed version of “recording 1,” which includes a video summary 710, an audio summary 720, and a text summary 730. The audio summary 720 corresponds to the text summary 730. The narration in the video summary 710 corresponds to the text summary 730 or the audio summary 720. Besides, the video summary also includes some visual, audio, or textual highlights from the virtual conference. The video summary 710, audio summary 720, and the text summary 730 can be generated by the chat and video conference provider 310 automatically using the recording of a virtual conference (e.g., “recording 1”). Alternatively, the video summary 730, audio summary 720, and the text summary 730 can be generated on demand by the host of the virtual conference as illustrated in FIG. 6.

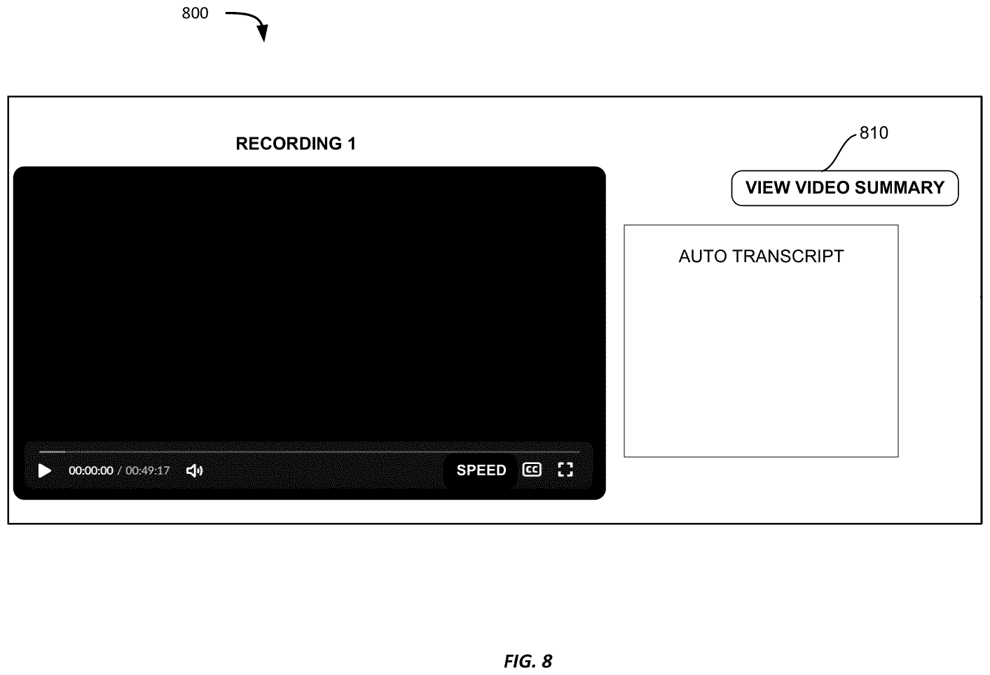

Referring now to FIG. 8, FIG. 8 is an example GUI 800 displaying a video recording on non-host participant client device. A host may share a link to the recording of a concluded virtual conference to non-host participants. Example GUI 800 is displayed on a non-host participant client device for the non-host participant to review the recording. Example GUI 800 also includes a “view video summary” button 810. The non-host participant may elect to watch the video summary of “recording 1” instead of the whole length of the recording.

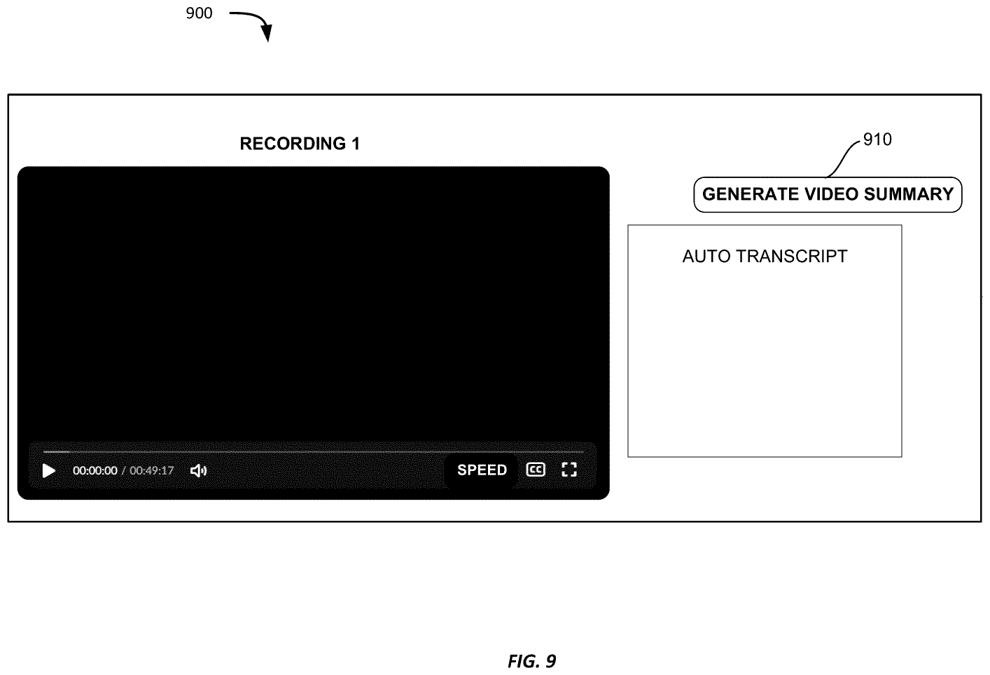

Referring now to FIG. 9, FIG. 9 is an example GUI 900 enabling generation of a video summary for a video recording on demand by a non-host client device. In some examples, a video summary is not generated by the chat and video conference provider 310 or the host of the concluded virtual conference. When a non-host participant opens a link to the recording, example GUI 900 is displayed. Example GUI 900 includes a “generate a video summary” button 910. The non-host participant can click or press button 910 to obtain a video summary of the recording to watch instead of watching the whole length of the recording.

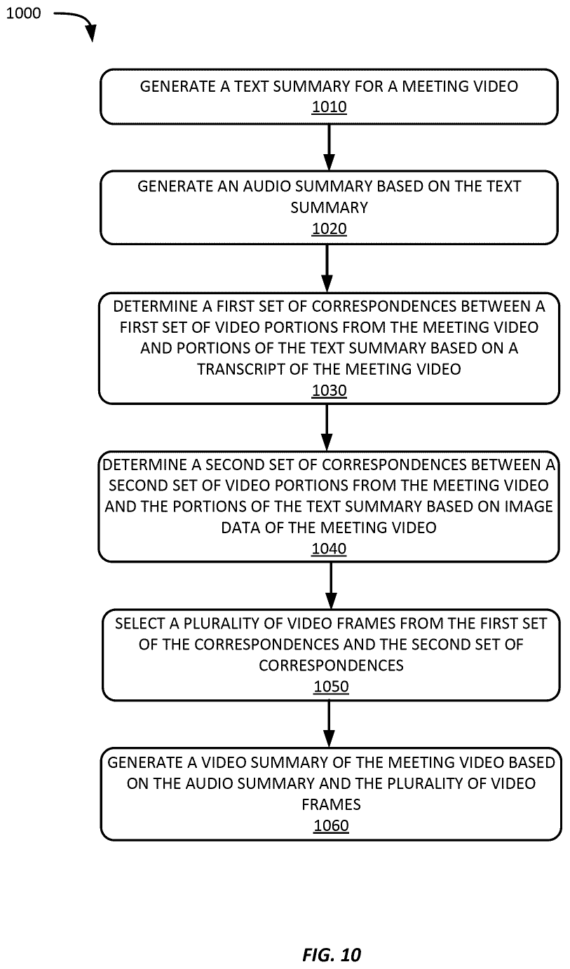

Referring now to FIG. 10, FIG. 10 shows an example method 1000 for generating a video summary for a meeting video. The example method 1000 will be discussed with respect to the system 400 shown in FIG. 4; however, any suitable system for generating a video summary for a meeting video may be used.

At block 1010, a chat and video conference provider 310 generates a text summary for a meeting video. The meeting video can be a video recording for a virtual conference conducted via the chat and video conference provider 310. The chat and video conference provider 310 generates the video recording if a host of the virtual conference elects to record the meeting. The chat and video conference provider 310 can also generate a transcript for the video recording. The summarization engine 440 of the chat and video conference provider 310 can generate a text summary for a meeting video generally as described in FIG. 3. For example, the summarization engine 440 implements a generative AI-based summarization model to generate a few sentences based on the transcript of the meeting video.

At block 1020, the chat and video conference provider 310 generates an audio summary based on the text summary. The text-to-speech engine 450 of the chat and video conference provider 310 can generate an audio version of the summary based on the text summary generally as described in FIG. 3. For example, the text summary has four sentences. The audio summary generated by the TTS engine 450 is a synthesized audio for the four sentences.

At block 1030, the chat and video conference provider 310 determines a first set of correspondences between a first set of video portions from the meeting video and portions of the text summary based on a transcription of the meeting video. The text aligner engine 460 of the chat and video conference provider 310 can determine the first set of correspondences between a first set of video portions from the meeting video and portions of the text summary generally as described in FIG. 3. For example, the text aligner engine 460 determines candidate portions in the transcript of the meeting video corresponding to each portion of the text summary using a similarity model. The candidate portions in the transcript are ranked based on corresponding similarity scores calculated by the similarity model with respect to each portion of the text summary. The candidate portion with the highest similarity score can be selected to map to the corresponding portion of the text summary. Thus, portions of the text summary are mapped with a set of portions in the transcript. The first set of video portions in the meeting video can be identified using time stamps for the set of portions in the transcript. The first set of video portions can be extracted and mapped to the portions of the text summary to create the first set of correspondences. Even though the text aligner engine 460 in this example processes text data in the transcript to determine the first set of correspondences, the text aligner engine 460 can alternatively process audio data to determine the first set of correspondences. For example, the utterances from the meeting video can be compared with the audio summary generated at block 1020 to identify portions of the meeting video that are most semantically similar to portions of the audio summary.

At block 1040, the chat and video conference provider 310 determines a second set of correspondences between a second set of video portions from the meeting video and portions of the text summary based on image data of the meeting video. The video aligner engine 470 of the chat and video conference provider 310 can determine the second set of correspondences generally as described in FIG. 3. For example, a similarity model is implemented to determine a semantic similarity between the image data extracted from the meeting video and a portion of the text summary to identify the image data that is most similar to the position of the text summary. Thus, a portion of the image data is identified to correspond to each portion of the text summary. A second set of video portions are identified based on the locations where the portions of the image data are extracted from the meeting video. The second set of video portions from the meeting video can be extracted and mapped to the portions of the text summary to form the second set of correspondences.

At block 1050, the chat and video conference provider 310 selects a plurality of video frames from the first set of correspondences and the second set of correspondences. The video summary generator 480 of the chat and video conference provider 310 can select a plurality of video frames from the first set of correspondences from block 1030 and the second set of correspondences from block 1040, generally as described in FIG. 3. For example, the video summary generator 480 identifies a plurality of key moments from the first set of video portions and the second set of video portions. Example key moments include presentation graphs, group photos, emojis, distinct sentiments, unusual engagements (e.g., heated discussion or lack of discussion). The key moments can be ranked based on user preferences and relationship to the text or audio summary. A plurality of video frames that includes top ranked key moments for each portion of the text or audio summary are selected to be included in the video summary. The video summary generator 480 can also extract terminologies and named entities from the transcript so that these words can be included in video frames of the video summary.

At block 1060, the chat and video conference provider 310 generates a video summary of the meeting video based on the audio summary and the plurality of video frames. The video summary generator 480 aligns and merges the video frames selected at block 1050 to each portion of the audio summary so that the content included in the video frame matches the content of the portion of the audio summary. For example, when the audio summary is talking about a presentation graph, the video frame of the video summary is showing the presentation graph.

Even though generally the chat and video conference provider 310 performs the actions described at blocks 1010-1010, the chat and video conference application 490 can also performs these actions to generate a video summary of a meeting video.

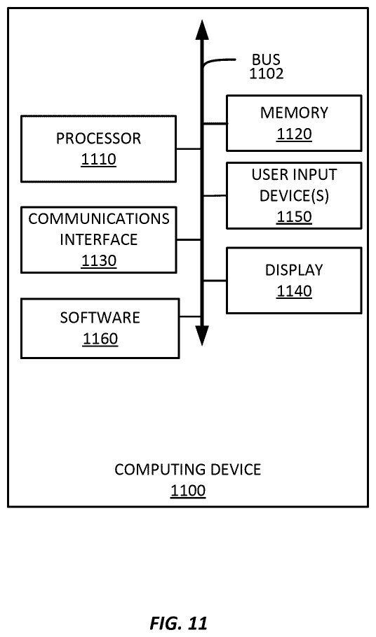

Referring now to FIG. 11, FIG. 11 shows an example computing device 1100 suitable for use in example systems or methods for generating a video summary of a meeting video according to this disclosure. The example computing device 1100 includes a processor 1110 which is in communication with the memory 1120 and other components of the computing device 1100 using one or more communications buses 1102. The processor 1110 is configured to execute processor-executable instructions stored in the memory 1120 to perform one or more methods for enabling a media input device configured for multi-step enablement according to different examples, such as part or all of the example method 1000 described above with respect to FIG. 10. In some embodiments, the computing device may include software 1160 for executing one or more methods described herein, such as for example, one or more steps of method 1000. The computing device 1100, in this example, also includes one or more user input devices 1150, such as a keyboard, mouse, touchscreen, microphone, etc., to accept user input. The computing device 1100 also includes a display 1140 to provide visual output to a user.

The computing device 1100 also includes a communications interface 930. In some examples, the communications interface 1130 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
generating a text summary for a meeting video;
generating an audio summary based on the text summary;
determining a first set of correspondences between a first set of video portions from the meeting video and portions of the text summary based on a transcript of the meeting video;
determining a second set of correspondences between a second set of video portions from the meeting video and the portions of the text summary based on image data of the meeting video;
selecting a plurality of video frames from the first set of correspondences and the second set of correspondences; and
generating a video summary of the meeting video based on the audio summary and the plurality of video frames.

2. The method of claim 1, wherein the text summary is generated using an artificial intelligence (AI)-based summarization model.

3. The method of claim 1, wherein the text summary is converted to the audio summary using a text-to-speech (TTS) model.

4. The method of claim 1, further comprising:
determining portions in the transcript corresponding to the portions of the text summary;
identifying time ranges for the portions in the transcript; and
selecting the first set of video portions of the meeting video based on the time ranges.

5. The method of claim 4, wherein determining portions in the transcript corresponding to the portions of the text summary comprises:
identifying candidate portions in the transcript corresponding to the portions of the text summary using a similarity model;
ranking the candidate portions to generates a ranking list of candidate portions based on corresponding similarity scores for the candidate portions; and
selecting the portions in the transcript with similarity scores greater than a threshold value from the ranking list of candidate portions.

6. The method of claim 1, wherein determining a second set of correspondences between a second set of portions of the meeting video and the portions of the text summary based on image data of the meeting video comprises:
identifying candidate video portions corresponding to the portions of the text summary by comparing the image data of the meeting video with the text summary using a similarity model; and
ranking the candidate video portions to generates a ranking list of candidate video portions based on corresponding similarity scores for the candidate video portions; and
selecting the second set of video portions with similarity scores greater than a threshold value from the ranking list of candidate video portions.

7. The method of claim 1, further comprising:
prior to selecting a plurality of video frames,
classifying the meeting video using a classification model to generate a meeting classifier; and
identifying a plurality of key moments at least from the first set of video portions and the second set of video portions based on the meeting classifier; and
selecting the plurality of video frames based on the plurality of key moments.

8. The method of claim 7, wherein the plurality of key moments is related to presentation graphs, group photos, emojis, sentiments, engagements in the meeting video.

9. The method of claim 7, wherein identifying a plurality of key moments further comprising extracting terminologies and named entities from the transcript.

10. The method of claim 7, wherein selecting a plurality of video frames based on the plurality of key moments comprises:
ranking the plurality of key moments based on user preferences and relationship to the audio summary to create a ranking list of key moments; and
selecting the plurality of video frames based on the ranking list of key moments.

11. The method of claim 1, wherein generating a video summary of the meeting video based the audio summary and the plurality of video frames comprises aligning the plurality of video frames to the portions of the audio summary.

12. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
generate a text summary for a meeting video;
generate an audio summary based on the text summary;
determine a first set of correspondences between a first set of video portions from the meeting video and portions of the text summary based on a transcript of the meeting video;
determine a second set of correspondences between a second set of video portions from the meeting video and the portions of the text summary based on image data of the meeting video;
select a plurality of video frames from the first set of correspondences and the second set of correspondences; and
generate a video summary of the meeting video based on the audio summary and the plurality of video frames.

13. The system of claim 12, wherein the text summary is generated using an artificial intelligence (AI)-based summarization model, and wherein the text summary is converted to the audio summary using a text-to-speech (TTS) model.

14. The system of claim 12, wherein the one or more processors are configured to execute further processor-executable instructions stored in the non-transitory computer-readable medium to:
determine portions in the transcript corresponding to the portions of the text summary;
identify time ranges for the portions in the transcript; and
select the first set of video portions of the meeting video based on the time ranges.

15. The system of claim 14, wherein determining portions in the transcript corresponding to the portions of the text summary comprises:
identifying candidate portions in the transcript corresponding to the portions of the text summary using a similarity model; and
ranking the candidate portions in the transcript to generates a ranking list of candidate portions based on similarity scores for the candidate portions in the transcript; and
selecting the portions in the transcript with similarity scores greater than a threshold value from the ranking list of candidate portions.

16. The system of claim 12, wherein determining a second set of correspondences between a second set of portions of the meeting video and the portions of the text summary based on image data of the meeting video comprises:
identifying candidate video portions corresponding to the portions of the text summary by comparing the image data of the meeting video with the text summary using a similarity model; and
ranking the candidate video portions to generates a ranking list of candidate video portions based on corresponding similarity scores for the candidate video portions; and
selecting the second set of video portions with similarity scores greater than a threshold value from the ranking list of candidate video portions.

17. The system of claim 12, wherein the one or more processors are configured to execute further processor-executable instructions stored in the non-transitory computer-readable medium to:
classify the meeting video using a classification model to generate a meeting classifier;
identify a plurality of key moments at least from the first set of video portions and the second set of video portions based on the meeting classifier, wherein the plurality of key moments is related to presentation graphs, group photos, emojis, sentiments, engagements in the meeting video; and
selecting a plurality of video frames based on the plurality of key moments.

18. A non-transitory computer-readable medium comprising processor-executable instructions configured to cause one or more processors to:
generate a text summary for a meeting video;
generate an audio summary based on the text summary;
determine a first set of correspondences between a first set of video portions from the meeting video and portions of the text summary based on a transcript of the meeting video;
determine a second set of correspondences between a second set of video portions from the meeting video and the portions of the text summary based on image data of the meeting video;
select a plurality of video frames from the first set of correspondences and the second set of correspondences; and
generate a video summary of the meeting video based on the audio summary and the plurality of video frames.

19. The non-transitory computer-readable medium of claim 18, further comprising processor-executable instructions configured to cause one or more processors to:
classify the meeting video using a classification model to generate a meeting classifier;
identify a plurality of key moments at least from the first set of video portions and the second set of video portions based on the meeting classifier, wherein the plurality of key moments is related to presentation graphs, group photos, emojis, sentiments, engagements in the meeting video;
rank the plurality of key moments based on user preferences and relationship to the audio summary to create a ranking list of key moments; and
select the plurality of video frames based on the ranking list of key moments.

20. The non-transitory computer-readable medium of claim 18, wherein generating a video summary of the meeting video based the audio summary and the plurality of video frames comprises aligning the plurality of video frames to the portions of the audio summary.
